(19) United States
(12) Patent Application Publication
(10) Pub. No.: US 2017/0293260 A1
(43) Pub. Date: Oct. 12, 2017

(54) PROJECTION APPARATUS AND IMAGE PROJECTION METHOD

(71) Applicant: Coretronic Corporation, Hsin-Chu (TW)

(72) Inventors: Fu-Ming Chuang, Hsin-Chu (TW); Chuan-Chung Chang, Hsin-Chu (TW)

(73) Assignee: Coretronic Corporation, Hsin-Chu (TW)

(21) Appl. No.: 15/480,390

(22) Filed: Apr. 6, 2017

(30) Foreign Application Priority Data
Apr. 7, 2016 (CN) 201610213096.9

(51) Int. Cl. G03H 1/00; G03H 1/22; G02B 27/01

(52) U.S. Cl. CPC G03H 1/0005; G02B 27/0172; G02B 27/0176; G03H 1/2205; G03H 1/2294; G02B 2027/0178; G02B 2027/0112; G02B 2027/0159; G02B 2027/0147; G02B 2027/0127; G02B 2027/0174; G03H 2001/0088; G03H 2001/2284

(57) ABSTRACT

A projection apparatus, adapted to project a virtual image to a projection target, and comprising a light source module, a light modulator, an optical lens and an optical film is provided. The light source module provides a light beam. The light modulator adjusts a transmission direction of the light beam. The light modulator modulates the light beam according to an input signal to generate the virtual image. The optical lens has a front view direction on a reference plane. The projection target receives an environment beam in the front view direction to form an environment image. The optical film projects the virtual image to the projection target along a projection direction. The front view direction and the projection direction have an included angle on the reference plane. Moreover, an image projection method is also provided.

### CROSS-REFERENCE TO RELATED APPLICATION

This application claims the priority benefit of China application serial no. 201610213096.9, filed on Apr. 7, 2016. The entirety of the above-mentioned patent application is hereby incorporated by reference herein and made a part of this specification.

### BACKGROUND OF THE INVENTION

### Field of the Invention

The invention relates to a projection apparatus and an image projection method, and particularly relates to a projection apparatus used for projection a virtual image and an image projection method.

### Description of Related Art

In related techniques, there are a variety of user-wearable display devices. Such type of the display devices can be broadly divided into a monocular viewing type and a binocular viewing type. Regarding the monocular viewing type, after an image displayed by a projection panel passes through an optical assembly, regardless whether it is directly imaged on a retina of a user or produce a virtual image to an eye of the user, the image content viewed by the user is the same to the content displayed by the projection panel, which only has two-dimensional (2D) image information. In order to present three-dimensional (3D) image information to the user, the display device is required to provide image information of different angles to the user at different time points through a time multitasking manner. Therefore, in order to facilitate the user viewing the 3D image information by using the monocular-viewing type display device, a holographic image corresponding to the 3D image can be calculated according to the 3D image to be displayed by using a computer holography technical means, and by using a light modulator having amplitude and phase modulating capability in collaboration with suitable light conditions, for example, wavelength, wave front and direction, the holographic image may produce a virtual image to be displayed at a specific direction and a specific position. Moreover, although computer-generated holography (CGH) can be adopted to provide the user with the 3D information, when such device is used in collaboration with a lens of the user, a reconstructed image generated by the CGH may have deformation in size or shape due to a focal power of the lens. In related techniques, an extra optical lens is generally adopted to compensate such deformation, though such compensation may enlarge a volume and a weight of the display device, which is not conducive to user's wearing.

The information disclosed in this “BACKGROUND OF THE INVENTION” section is only for enhancement of understanding of the background of the described technology and therefore it may contain information that does not form the prior art that is already known to a person of ordinary skill in the art. Further, the information disclosed in the “BACKGROUND OF THE INVENTION” section does not mean that one or more problems to be resolved by one or more embodiments of the invention were acknowledged by a person of ordinary skill in the art.

### SUMMARY OF THE INVENTION

The invention is directed to a projection apparatus and an image projection method. The projection apparatus is adapted to project a virtual image onto a projection target, such that a user is able to view 3D image information, and image information of different angles can be provided to the user at different time points without using a time multitasking manner through a display device. Therefore, the user may view 3D image information by using a monocular-viewing type display device. Moreover, in the invention, it is unnecessary to use an extra optical lens to compensate a deformed image, so that the projection apparatus of the invention has a small volume and light weight, which is conducive to user's wearing.

Other objects and advantages of the invention can be further illustrated by the technical features broadly embodied and described as follows.

In order to achieve one or a portion of or all of the objects or other objects, an embodiment of the invention provides a projection apparatus. The projection apparatus is adapted to project a virtual image to a projection target. The projection apparatus includes a light source module, a light modulator, an optical lens and an optical film. The light source module is adapted to provide a light beam. The light modulator is disposed on a transmission path of the light beam, and is adapted to adjust a transmission direction of the light beam. The light modulator modulates the light beam to generate the virtual image according to an input signal. The optical lens is disposed on a transmission path of the virtual image, and has a front view direction on a reference plane. The projection target receives an environment beam in the front view direction of the optical lens to form an environment image. The optical film is disposed on the transmission path of the virtual image, and is adapted to project the virtual image to the projection target along a projection direction. The front view direction and the projection direction have an included angle on the reference plane.

In order to achieve one or a portion of or all of the objects or other objects, an embodiment of the invention provides an image projection method. The image projection method is adapted to a projection apparatus. The image projection method is adapted to project a virtual image to a projection target. The projection apparatus includes a light source module, a light modulator, an optical lens and an optical film. The image projection method includes following steps. A light beam is provided by the light source module. The light beam is modulated according to an input signal by using the light modulator, so as to generate the virtual image. An environment beam is received in a front view direction of a reference plane by using the optical lens, so as to form an environment image on the projection target. The virtual image is projected to the projection target along a projection direction by using the optical film. The front view direction and the projection direction have an included angle on the reference plane.

According to the above description, the embodiment of the invention has at least one of the following advantages and effects. In an exemplary embodiment of the invention, the light modulator generates the virtual image according to the input signal, where the projection direction thereof deviates from the front view direction, and the virtual image is projected to the projection target in a predetermined angle.

In order to make the aforementioned and other features and advantages of the invention comprehensible, several exemplary embodiments accompanied with figures are described in detail below.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a projection apparatus according to an embodiment of the invention.

FIG. 2 is a schematic diagram of a projection apparatus according to another embodiment of the invention.

FIG. 3 is a schematic diagram of a projection apparatus according to another embodiment of the invention.

FIG. 4 is a schematic diagram of a projection apparatus according to another embodiment of the invention.

FIG. 5 is a schematic diagram of a projection apparatus according to another embodiment of the invention.

FIG. 6 is a schematic diagram of a projection apparatus according to another embodiment of the invention.

FIG. 7 is a schematic diagram of a projection apparatus according to another embodiment of the invention.

FIG. 8 is a schematic diagram of a projection apparatus according to another embodiment of the invention.

FIG. 9 is a flowchart illustrating an image projection method according to an embodiment of the invention.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The invention will now be described more fully with reference to the accompanying drawings, in which exemplary embodiments of the invention are shown. The terms used herein such as “above”, “below”, “front”, “back”, “left” and “right” are for the purpose of describing directions in the figures only and are not intended to be limiting of the invention.

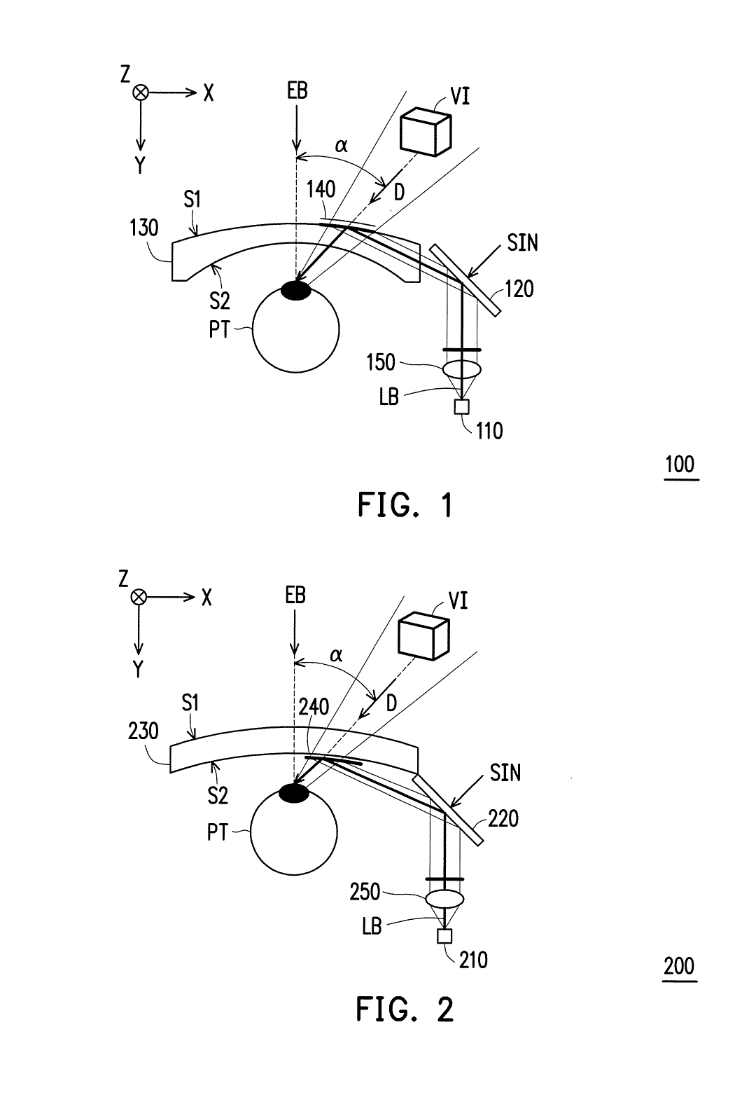

FIG. 1 is a schematic diagram of a projection apparatus according to an embodiment of the invention. The projection apparatus 100 of the embodiment includes a light source module 110, a light modulator 120, an optical lens 130 and an optical film 140 and a lens module 150. The light source module 110 is adapted to provide a light beam LB. The light source module 110, for example, includes one or a plurality of light-emitting diodes (LEDs) for providing the light beam LB. The light beam LB is, for example, a single color light beam with a wavelength range, or a light beam mixed with different wavelengths, for example, a white light mixed with a red light, a green light and a blue light, which is not limited by the invention. However, a light source patter and the wavelength range of the light beam LB are not limited by the invention. In the embodiment, the lens module 150 is disposed on a transmission path of the light beam LB, and is adapted to transmit the light beam LB to the light modulator 120. In the embodiment, the lens module 150 includes one or a plurality of lenses disposed on the transmission path of the light beam LB between the light source module 110 and the light modulator 120. In the embodiment, the lens module 150 may be a single lens, though the invention is not limited thereto. In other embodiment, the lens module 150, for example, includes a plurality of lenses disposed on at least one of the transmission path of the light beam LB between the light source module 110 and the light modulator 120 and the transmission path of the light beam LB between the light modulator 120 and the optical film 140.

In an embodiment, the lens module 150, for example, includes a plurality of solid lenses made of a light penetrating material such as glass or polymer, etc., which have a fixed focal length. The lens module 150 is a combination of a plurality of solid lenses, and a valid focal length thereof can be changed by adjusting a gap between the solid lenses, such that the lens module 150 has a zoom function. In an embodiment, the lens module 150, for example, includes a liquid crystal lens (LC-lens), an electrowetting lens (EW-lens), a liquid-filled membrane lens or a dielectric liquid lens, and an electric signal is adopted to change the valid focal length of the lens module 150, such that the lens module has the zoom function. In the embodiment, since enough instructions and recommendations for detailed steps and implementation of the method for changing the valid focal length of the lens module 150 can be learned from general acknowledge of the related technical field, detailed description thereof is not repeated.

In the embodiment, the light modulator 120 is disposed on the transmission path of the light beam LB, and is adapted to adjust a transmission direction of the light beam LB. For example, the light modulator 120 reflects the light beam LB coming from the lens module 150 to the optical lens 130. In the embodiment, the light modulator 120 modulates the light beam LB according to an input signal SIN to generate a virtual image VI, wherein the input signal SIN is output from an image source device having image signals, for example, a smartphone or a laptop, etc. . . . . In the embodiment, the virtual image VI is located at a side of a first surface S1 of the optical lens 130. In other words, the projection target PT (for example, a human eye) may view the virtual image VI having a depth of field at the side of the first surface S1 of the optical lens 130. The light modulator 120 is disposed at other position beside the side of the first surface S1. For example, the light modulator 120 is disposed outside an area of an included angle α, wherein an area of an included angle α is defined that the area is contained by the front view direction (Y) and the projection direction (D) such that the modulator 120 is free from the transmission path of the environment beam EB.

In an embodiment, the light modulator 120 is, for example, disposed at the side of a second surface S2 of the optical lens 130.

In the embodiment, the light modulator 120 is, for example, a spatial light modulator (SLM), the light modulator 120 receives image information carried by the input signal SIN, and loads one-dimensional or two-dimensional light data to the carried image information. The light modulator 120 is, for example, controlled by an electric driving signal varied along with time or other control signal for changing amplitude or intensity, phase, polarization of a spatial light distribution. In the embodiment, the pattern of the virtual image VI illustrated in FIG. 1 is only an example, which is not used for limiting the invention.

In an embodiment, the light modulator 120 is, for example, a reflective or a transmissive SLM. The reflective SLM is, for example, liquid crystal on silicon (LCOS) or digital micro-mirror device (DMD), etc., and the transmissive SLM is, for example, a transparent liquid crystal panel. Moreover, based on different methods for inputting the control signal, the light modulator 120 is, for example, an optically addressed spatial light modulator (OASLM) or an electrically addressed spatial light modulator (EASLM), and the implementation and type of the light modulator 120 are not limited by the invention. In the embodiment, since enough instructions and recommendations for detailed steps and implementation of the method for generating the virtual image VI by the light modulator 120 can be learned from general acknowledge of the related technical field, detailed description thereof is not repeated.

In the embodiment, the optical lens 130 is disposed on a transmission path of the virtual image VI. The optical lens 130 has a front view direction Y on a reference plane XY. The projection target PT receives an environment beam EB in the front view direction Y to form an environment image at the projection target PT. To be specific, in the embodiment, the optical lens 130 has the first surface S1 and the second surface S2. Taking the optical lens 130 as a reference, the environment light EB of the embodiment is transmitted from the side of the first surface S1 to the side of the second surface S2 along the front view direction Y, so as to form the environment image at the projection target PT.

In the embodiment, the optical lens 130 is, for example, a non-plane lens with a refractive power, for example, a biconcave lens, a biconvex lens, a concave-convex lens, a convex-concave lens, a plano-convex lens, a plano-concave lens, etc. In the embodiment, the optical lens 130 can also be a planar lens. The implementation and type of the optical lens 130 are not limited by the invention.

In the embodiment, the projection target PT is, for example, the user's eye, and the environment image is, for example, a field of view image within a visual range of the user. The virtual image VI is projected to the user's eye and is imaged on a retina of the eye together with the environment image. Relative to the virtual image VI, the environment image can be a foreground or a background, which is not limited by the invention. In the embodiment, the projection target PT can also be an image capturing device or image recording device to replace the position of the user's eye, for example, a charge coupled device image sensor (CCD image sensor) or a complementary metal oxide semiconductor (CMOS) image sensor, etc., which is not limited by the invention.

In the embodiment, the optical film 140 is, for example, disposed on the transmission path of the virtual image VI and on the first surface S1 of the optical lens 130. In an embodiment, the optical film 140 may also be disposed on the second surface S2 of the optical lens 130. The configuration position of the optical film 140 is not limited by the invention. In the embodiment, the optical film 140 is adapted to project the virtual image VI to the projection target PT along a projection direction D. In the embodiment, the front view direction Y of the optical lens 130 and the projection direction D of the virtual image VI have an included angle α on the reference plane XY. The included angle α is, for example, an acute angle, and the light modulator 120 is disposed outside the included angle c.

In the embodiment, the optical film 140, for example, includes one of or multiple of a normal prism sheet, a multi-functional prism sheet, a micro-lens film, a reflective polarizer and a diffuser film, etc., or a combination thereof. The implementation and type of the optical film 140 are not limited by the invention.

In the embodiment, based on the image information displayed by the light modulator 120, the reconstructed virtual image VI is generated by the light source module 110, the optical lens 130 and the lens module 150. The virtual image VI is further presented in the projection direction D deviated from the front view direction Y through the optical film 140 capable of changing the direction of the light beam LB.

In the embodiment, the projection apparatus 100 is, for example, configured on a wearable device, for example, a pair of glasses, in an embedded or plugin manner. In the implementation that the projection apparatus 100 is configured on the wearable device in the embedded manner, the optical lens 130 is, for example, one of the lenses of the pair of glasses, and the other optical assembly can be disposed on a glass frame or glass rack. In the implementation that the projection apparatus 100 is configured on the wearable device in the plugin manner, the whole of the projection apparatus 100 is, for example, disposed on the glass frame or glass rack. The implementation and type of the wearable device are not limited by the invention.

FIG. 2 is a schematic diagram of a projection apparatus according to another embodiment of the invention. The projection apparatus 200 of the embodiment is similar to the projection apparatus 100 of FIG. 1, and a main difference therebetween is that the optical film 240 is disposed on the second surface S2 of the optical lens 230, and the light modulator 220 is disposed at the side of the second surface S2 of the optical lens 230. Moreover, the refractive powers of the two surfaces of the optical lens 230 of the embodiment are different to that of the optical lens 130 of FIG. 1.

To be specific, the optical film 240 changing the projection direction D is, for example, disposed at the side of the optical lens 230 close to the projection target PT. Based on the image information displayed by the light modulator 220, the reconstructed virtual image VI is generated through the light source module 210, the optical lens 230 and the lens module 250. The virtual image VI is further presented in the projection direction D deviated from the front view direction Y through the optical film 240 capable of changing the direction of the light beam LB.

Moreover, since enough instructions and recommendations for operations of other optical assembly and the image projection method of the embodiment can be learned from the description of the embodiment of FIG. 1, detailed description thereof is not repeated.

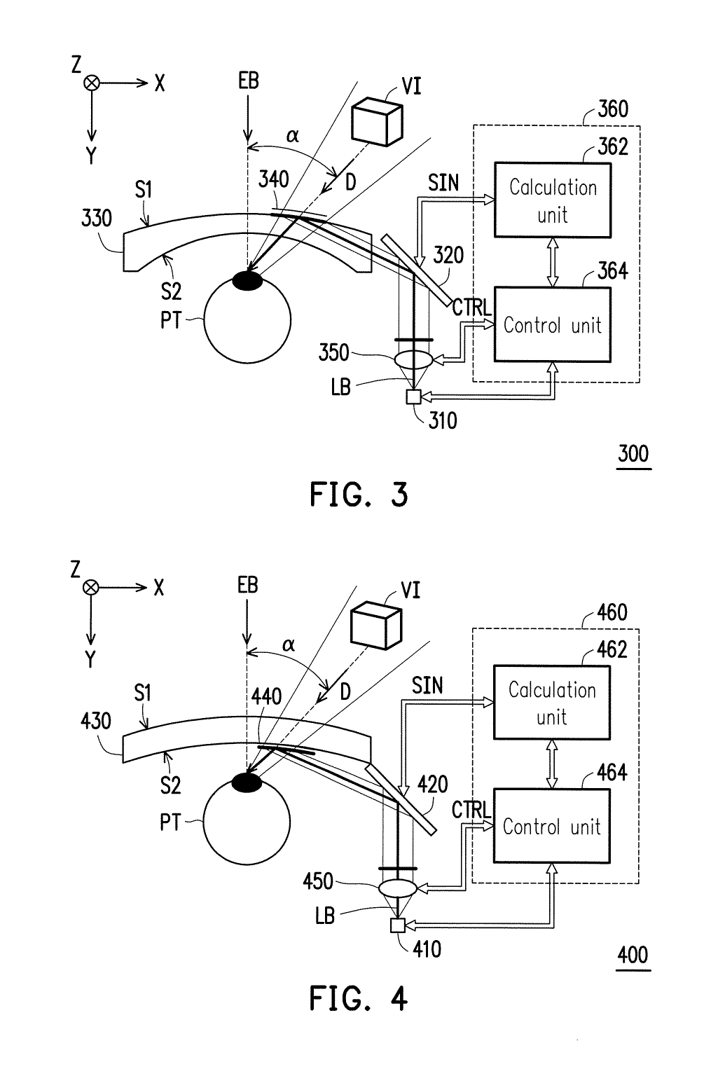

FIG. 3 is a schematic diagram of a projection apparatus according to another embodiment of the invention. The projection apparatus 300 of the embodiment is similar to the projection apparatus 100 of FIG. 1, and a main difference therebetween is that the projection apparatus 300 further includes an image adjusting unit 360. To be specific, the image adjusting unit 360 includes a calculation unit 362 and a control unit 364. The calculation unit 362 is connected to the light modulator 320. The calculation unit 362 is adapted to adjust an image parameter of the input signal SIN, and provides the input signal SIN to the light modulator 320, and the light modulator 320 adjusts the light beam LB provided by the light source module 310 according to the input signal SIN, so as to produce or adjust the virtual image VI to be displayed. The image parameter includes image content to be displayed by the light modulator 320, but not limited, color performance, sharpness, contrast, gray level, brightness, imaging position and depth information, etc. of the virtual image VI, and the type of the image parameter is not limited by the invention. Therefore, in the embodiment, the calculation unit 362 may perform optical information calculation and image signal processing to the input signal SIN in real-time, and outputs a result to the light modulator 320, and the light modulator 320 may generate the virtual image VI to be projected. In the embodiment, the type of the virtual image VI illustrated in FIG. 3 is only an example, and the invention is not limited thereto. The implementation of the virtual image VI and the image content thereof are, for example, determined by an image processing result of the input signal SIN obtained by the calculation unit 362.

In the embodiment, the control unit 364 is connected to the calculation unit 362. The control unit 364 is adapted to output a control signal CTRL to adjust a position of the lens module 350, so as to adjust the image parameter of the virtual image VI. For example, the lens module 350 is a combination of a plurality of solid lenses, and is disposed on a mechanism assembly. The control unit 364 includes an actuator, which is adapted to adjust a gap of a position of each of the solid lenses to change a valid focal length of the lens module 350. Therefore, the lens module 350 has a zoom function to adjust the image parameter of the virtual image VI. Moreover, in an embodiment, the lens module 350 may also include a liquid crystal lens, and the control unit 364 uses the control signal to change a valid focal length of the liquid crystal lens, so that the lens module 350 has the zoom function.

In the embodiment, the calculation unit 362 and the control unit 364, for example, include a central processing unit (CPU), a microprocessor, a digital signal processor (DSP), a programmable controller, a programmable logic device (PLD) or other similar devices or a combination of the devices, which is not limited by the invention. Moreover, in an embodiment, various control functions of the calculation unit 362 and the control unit 364 can be implemented as a plurality of program codes. Theses program codes are stored in a memory (not shown), and are executed by a processor circuit or a controller circuit in the calculation unit 362 and the control unit 364. Alternatively, in an embodiment, the various control functions of the calculation unit 362 and the control unit 364 can be implemented as one or a plurality of circuits. The various control functions of the calculation unit 362 and the control unit 364 can be implemented in a software manner or a hardware manner, which is not limited by the invention.

Therefore, in the embodiment, the projection apparatus 300 adopts the image adjusting unit 360 in collaboration with the light modulator 320 to correct and compensate image deformation of the virtual image VI caused by the optical lens 330 and the lens module 350, and further adjusts the display position of the virtual image VI, and may further change an image depth and a resolution of the virtual image VI through time multiplexing in collaboration with user's persistence of vision.

Moreover, since enough instructions and recommendations for operations of other optical assembly and the image projection method of the embodiment can be learned from the description of the embodiments of FIG. 1 and FIG. 2, detailed description thereof is not repeated.

FIG. 4 is a schematic diagram of a projection apparatus according to another embodiment of the invention. The projection apparatus 400 of the embodiment is similar to the projection apparatus 300 of FIG. 3, and a main difference therebetween is that the optical film 440 is disposed on the second surface S2 of the optical lens 430, and the light modulator 420 is disposed at the side of the second surface S2 of the optical lens 430. Moreover, the refractive powers of the two surfaces of the optical lens 430 of the embodiment are different to that of the optical lens 330 of FIG. 3. To be specific, the optical film 430 changing the projection direction D is, for example, disposed at the side of the optical lens 430 close to the projection target PT. Based on the image information displayed by the light modulator 420, the reconstructed virtual image VI is generated through the light source module 410, the optical lens 430 and the lens module 450. The virtual image VI is further presented in the projection direction D deviated from the front view direction Y through the optical film 440 capable of changing the direction of the light beam LB.

Moreover, since enough instructions and recommendations for operations of other optical assembly and the image projection method of the embodiment can be learned from the description of the embodiments of FIG. 1 to FIG. 3, detailed description thereof is not repeated.

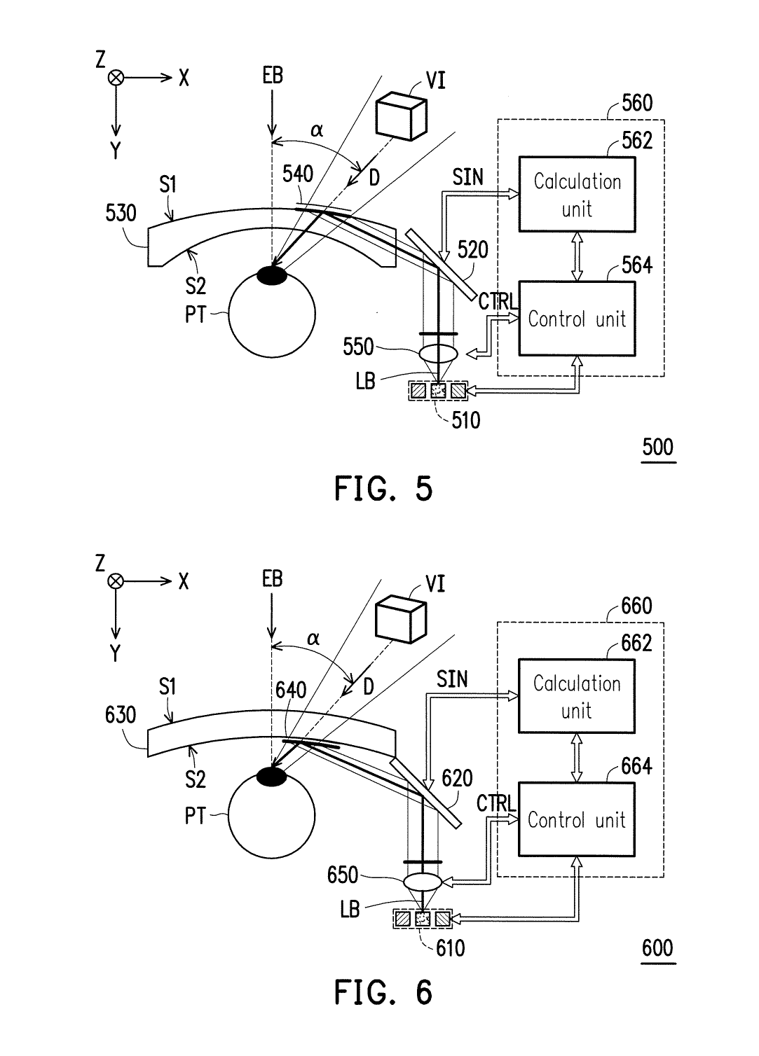

FIG. 5 is a schematic diagram of a projection apparatus according to another embodiment of the invention. The projection apparatus 500 of the embodiment is similar to the projection apparatus 300 of FIG. 3, and a main difference therebetween is that the light beam LB provided by the light source module 510 is a chromatic light including a plurality of colors. Therefore, the light source module 510 is, for example, a LED light source including a plurality of different colors such as red, green and blue, etc. To be specific, based on different color light configuration of time multitasking of the projection apparatus 500, the user may view a non-single color image. The control unit 564 modulates the light source of different color lights in time division. The calculation unit 562 cooperates or receives a color light signal modulated by the control signal 564 to calculate and generate corresponding digital holography information for outputting to the light modulator 520. Therefore, based on the image information displayed by the light modulator 520, the reconstructed virtual image VI is generated through the light source module 510, the optical lens 530 and the lens module 550. The virtual image VI is further presented in the projection direction D deviated from the front view direction Y through the optical film 540 capable of changing the direction of the light beam LB.

Moreover, since enough instructions and recommendations for operations of other optical assembly and the image projection method of the embodiment can be learned from the description of the embodiments of FIG. 1 to FIG. 4, detailed description thereof is not repeated.

FIG. 6 is a schematic diagram of a projection apparatus according to another embodiment of the invention. The projection apparatus 600 of the embodiment is similar to the projection apparatus 500 of FIG. 5, and a main difference therebetween is that the optical film 640 is disposed on the second surface S2 of the optical lens 630, and the light modulator 620 is disposed at the side of the second surface S2 of the optical lens 630. Moreover, the refractive powers of the two surfaces of the optical lens 630 of the embodiment are different to that of the optical lens 530 of FIG. 5. To be specific, the optical film 630 changing the projection direction D is, for example, disposed at the side of the optical lens 630 close to the projection target PT. Based on the image information displayed by the light modulator 620, the reconstructed virtual image VI is generated through the light source module 610, the optical lens 630 and the lens module 650. The virtual image VI is further presented in the projection direction D deviated from the front view direction Y through the optical film 640 capable of changing the direction of the light beam LB.

Moreover, since enough instructions and recommendations for operations of other optical assembly and the image projection method of the embodiment can be learned from the description of the embodiments of FIG. 1 to FIG. 5, detailed description thereof is not repeated.

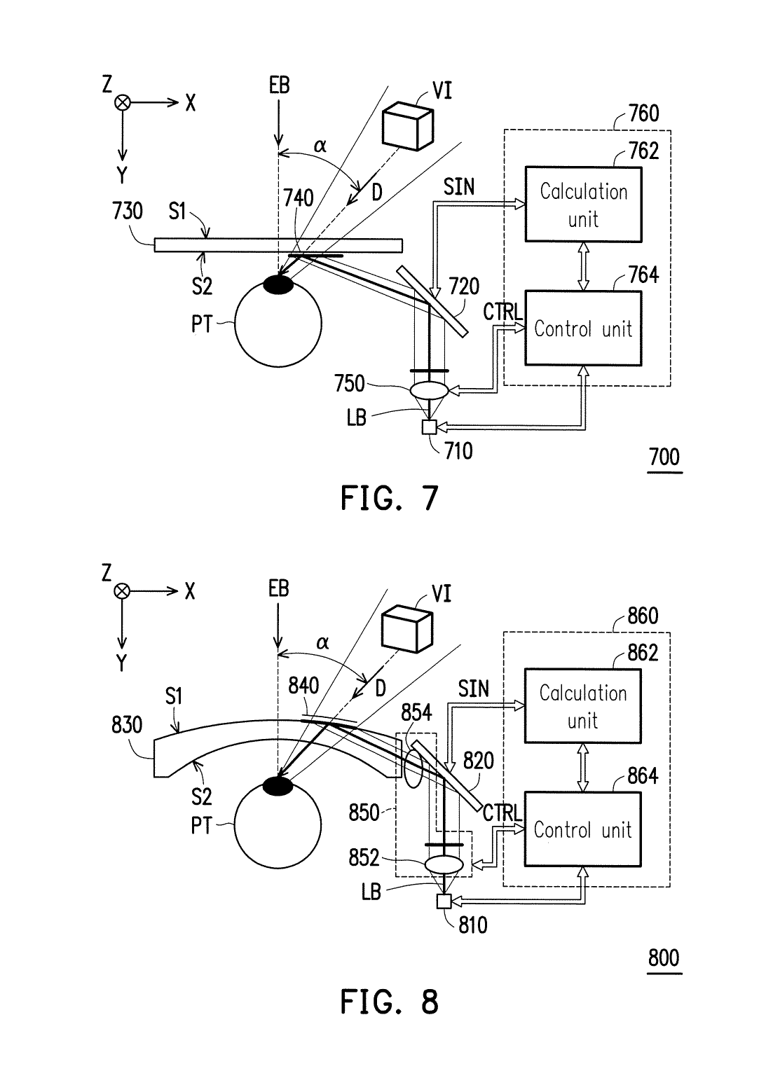

FIG. 7 is a schematic diagram of a projection apparatus according to another embodiment of the invention. The projection apparatus 700 of the embodiment is similar to the projection apparatus 400 of FIG. 4, and a main difference therebetween is that the optical lens 730 is a plane lens. Since enough instructions and recommendations for operations of other optical assembly and the image projection method of the embodiment can be learned from the description of the embodiments of FIG. 1 to FIG. 6, detailed description thereof is not repeated.

FIG. 8 is a schematic diagram of a projection apparatus according to another embodiment of the invention. The projection apparatus 800 of the embodiment is similar to the projection apparatus 300 of FIG. 3, and a main difference therebetween is that the lens module 850 includes a plurality of lenses 852 and 854. To be specific, the lens 852 is disposed on the transmission path of the light beam LB between the light source module 810 and the light modulator 820, and is used for transmitting the light beam LB to the light modulator 820. The lens 854 is disposed on the transmission path of the light beam LB between the light modulator 820 and the optical film 840, and is used for transmitting the light beam LB to the optical film 840. Therefore, in the embodiment, the lens 852 is close to the light source module 810 to provide wave front lights having different curvatures. The lens 854 is disposed between the light modulator 820 and the optical film 840 changing the projection direction D, and is adapted to change a display position of the virtual image VI.

Since enough instructions and recommendations for operations of other optical assembly and the image projection method of the embodiment can be learned from the description of the embodiments of FIG. 1 to FIG. 7, detailed description thereof is not repeated.

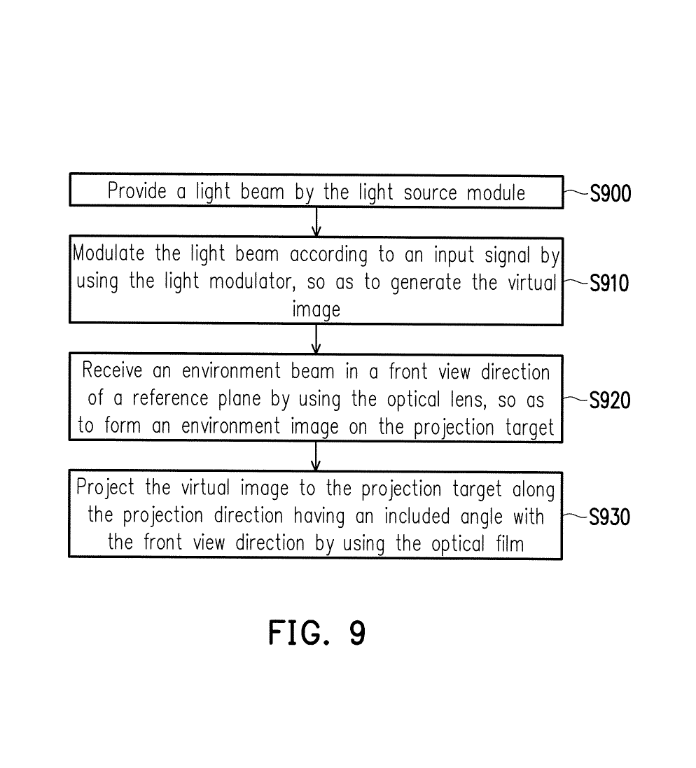

FIG. 9 is a flowchart illustrating an image projection method according to an embodiment of the invention. Referring to FIG. 1 and FIG. 9, the image projection method of the embodiment is at least adapted to any one of the projection apparatuses of FIG. 1 to FIG. 8, which is not limited by the invention. Taking the projection apparatus 100 of FIG. 1 as an example, in step S900, the light beam LB is provided by the light source module 110. In step S910, the light beam LB is modulated according to the input signal SIN by using the light modulator 120, so as to generate the virtual image VI. In step S920, the environment beam EB is received in the front view direction Y of the reference plane XY by using the optical lens 130, so as to form an environment image on the projection target PT. In step S930, the virtual image VI is projected to the projection target PT along the projection direction D having an included angle α with the front view direction Y by using the optical film 140. Moreover, since enough instructions and recommendations for the image projection method of the embodiment can be learned from the description of the embodiments of FIG. 1 to FIG. 8, detailed description thereof is not repeated.

In summary, the embodiment of the invention has at least one of the following advantages and effects. In an exemplary embodiment of the invention, the light modulator is irradiated by a light beam coming from the light source module and the lens module, and generates the virtual image according to the input signal. After the virtual image passes through the optical film located at the surface of the optical lens and capable of refracting a direction of the light beam, a projection direction thereof deviates from the front view direction, so that the virtual image can be projected to the projection target in a direction deviating from the front view direction by a predetermined angle.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents. Moreover, any embodiment of or the claims of the invention is unnecessary to implement all advantages or features disclosed by the invention. Moreover, the abstract and the name of the invention are only used to assist patent searching. Moreover, “first”, “second”, etc. mentioned in the specification and the claims are merely used to name the elements and should not be regarded as limiting the upper or lower bound of the number of the components/devices.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A projection apparatus, adapted to project a virtual image onto a projection target, comprising:
a light source module, adapted to provide a light beam;
a light modulator, disposed on a transmission path of the light beam, adapted to adjust a transmission direction of the light beam and modulate the light beam to generate the virtual image according to an input signal;
an optical lens, disposed on a transmission path of the virtual image, and having a front view direction on a reference plane, wherein the projection target is adapted to receive an environment beam in the front view direction of the optical lens to form an environment image; and
an optical film, disposed on the transmission path of the virtual image, and adapted to transmit the virtual image to the projection target along a projection direction, wherein the front view direction and the projection direction have an included angle on the reference plane.

2. The projection apparatus of claim 1, wherein the optical lens has a first surface and a second surface opposite to the first surface, and the optical film is disposed on the first surface or the second surface.

3. The projection apparatus of claim 2, wherein the optical lens is taken as a reference, the virtual image is imaged at a side of the first surface, and the light modulator is disposed at a side of the second surface, wherein the side of the first surface is opposite to the side of the second surface.

4. The projection apparatus of claim 2, wherein the optical lens is taken as a reference, the environment beam is adapted to be transmitted from a side of the first surface to a side of the second surface along the front view direction, so as to form the environment image onto the projection target.

5. The projection apparatus of claim 1, wherein the included angle between the front view direction and the projection direction on the reference plane is an acute angle, and the light modulator is disposed outside an area of the included angle.

6. The projection apparatus of claim 1, further comprising:
an image adjusting unit, adapted to provide the input signal, and adjusting an image parameter of the input signal, so that the light modulator is adapted to modulate the light beam according to the input signal, so as to generate or adjust the virtual image.

7. The projection apparatus of claim 1, wherein the optical lens is a plane lens or a non-plane lens with a refractive power.

8. The projection apparatus of claim 1, wherein the light beam provided by the light source module is a single color light or a chromatic light comprising a plurality of colors.

9. The projection apparatus of claim 1, further comprising:
a lens module, disposed on the transmission path of the light beam, and adapted to transmit the light beam to at least one of the light modulator and the optical film, wherein the lens module comprises one or a plurality of lenses disposed on at least one of the transmission path of the light beam between the light source module and the light modulator and the transmission path of the light beam between the light modulator and the optical film.

10. The projection apparatus of claim 9, further comprising:
an image adjusting unit, adapted to output a control signal to adjust a position of the lens module, so as to adjust the image parameter of the virtual image.

11. An image projection method, adapted to use for a projection apparatus, wherein the projection apparatus is adapted to project a virtual image to a projection target, and comprising a light source module, a light modulator, an optical lens and an optical film, the image projection method comprising:
providing a light beam by the light source module;
modulating the light beam according to an input signal by using the light modulator, so as to generate the virtual image;
receiving an environment beam in a front view direction of a reference plane by using the optical lens, so as to form an environment image on the projection target; and
projecting the virtual image to the projection target along a projection direction by using the optical film, wherein the front view direction and the projection direction have an included angle on the reference plane.

12. The image projection method of claim 11, wherein the optical lens has a first surface and a second surface opposite to the first surface, and the optical film is disposed on the first surface or the second surface.

13. The image projection method of claim 12, wherein in the step of projecting the virtual image to the projection target along the projection direction, the optical lens is taken as a reference, the virtual image is adapted to be imaged at a side of the first surface, and the light modulator is disposed at a side of the second surface.

14. The image projection method of claim 12, wherein in the step of receiving the environment beam in the front view direction of the reference plane by using the optical lens, so as to form the environment image on the projection target, the optical lens is taken as a reference, the environment beam is transmitted from a side of the first surface to a side of the second surface along the front view direction, so as to form the environment image on the projection target.

15. The image projection method of claim 11, wherein the included angle between the front view direction and the projection direction on the reference plane is an acute angle, and the light modulator is disposed outside an area of the included angle.

16. The image projection method of claim 11, wherein the projection apparatus further comprises an image adjusting unit, and the image projection method further comprises:
providing the input signal from the image adjusting unit, and adjusting an image parameter of the input signal, so as to modulate the light beam to generate or adjust the virtual image according to the input signal.

17. The image projection method of claim 11, wherein the optical lens is a plane lens or a non-plane lens with a refractive power.

18. The image projection method of claim 11, wherein the light beam provided by the light source module is a single color light or a chromatic light comprising a plurality of colors.

19. The image projection method of claim 11, wherein the projection apparatus further comprises a lens module, and the image projection method further comprises:
transmitting the light beam to at least one of the light modulator and the optical film by using the lens module, wherein the lens module comprises one or a plurality of lenses disposed on at least one of the transmission path of the light beam between the light source module and the light modulator and the transmission path of the light beam between the light modulator and the optical film.

20. The image projection method of claim 19, wherein the projection apparatus further comprises an image adjusting unit, and the image projection method further comprises:
outputting a control signal to adjust a position of the lens module by using the image adjusting unit, so as to adjust the image parameter of the virtual image.
